(19) United States
(12) Patent Application Publication
(10) Pub. No.: US 2016/0316969 A1
(43) Pub. Date: Nov. 3, 2016

(54) MULTI-CAVITY COOKING DEVICE

(71) Applicant: RICHARD E. WHITE, Lancaster, CA (US)

(72) Inventor: RICHARD E. WHITE, Lancaster, CA (US)

(21) Appl. No.: 15/130,998

(22) Filed: Apr. 17, 2016

(51) Int. Cl. A47J 37/10; A47J 27/13

(52) U.S. Cl. CPC A47J 37/108; A47J 27/13

(57) ABSTRACT

The invention details a plate (as in a divider wall or bulkhead) that separates two or more foods inside of a cooking pot, saucepan, slow cooker, or frying pan while the food is being cooked. A plate divider that allows you to be able to cook two or more different foods or meals in the same pot or pan without their contents being mixed together. Each of the different foods remains in the boundary or perimeter of the pan and the plate while the food is being cooked and they do not leak into each other. The Multi-Cavity Cooking Device: Prevents from having to use so many pots and pans while cooking; Saves time by not having to wash so many dishes; Helps keep so many dirty pots and pans from cluttering up; Saves money by not having to buy so many pots and pans.

The plate is removable, that may be removed by sliding in and out of a protruding or indented groove or slot between two walls inside of the pot. The groove may extend to the whole dimension or diameter of the pot's interior, or it may stop short from the top of the pot to be able to allow space for a lid to sit on top of the pan. The groove and slot that the plate slides into being described as in protruding or projecting from the pan and indented as in having an indentation or notch in the pan with two walls, as illustrated in the drawings.

The pan is not limited to a single groove or plate. The pan may have more than one groove and plate. There are no limitations to the size of the indented or protruding groove, and the walls of the groove can be any size in depth or measurement.

The surface of the plate may be of any structure, such as solid or perforated.

The plate may be solid with perforated holes around the perimeter and protected by an interior wall to keep food from dripping through.

The plate can be any size and has no limits in size and it can work with any pot, pan, or slow cooker that cooks food; big or small, and of any shape.

The plate can be positioned in any direction of the pot as long as the plate separates two or more zones within the pot. The zones are not limited to a certain degree and they do not need to be symmetrical.

The plate is not limited to a certain material. It can work with any type of material that is able to withstand high heat temperatures to cook food.

The plate may slide into the groove with a tight snug, to help prevent the foods from leaking into the other zone.

The groove and the plate may be altered, as in taking on any shape or form, to create a tighter watertight seal.

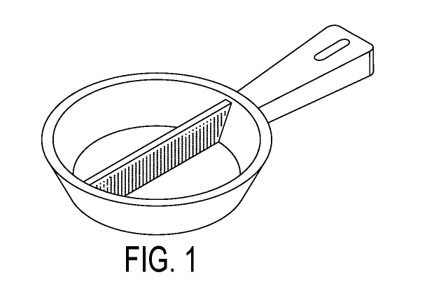

In reference to FIG. 1, illustrated is a pan with a perforated plate sitting inside as in ready to cook food.

The pan and plate is shown with a gap between the plate and the top of the pan, to allow space for a lid.

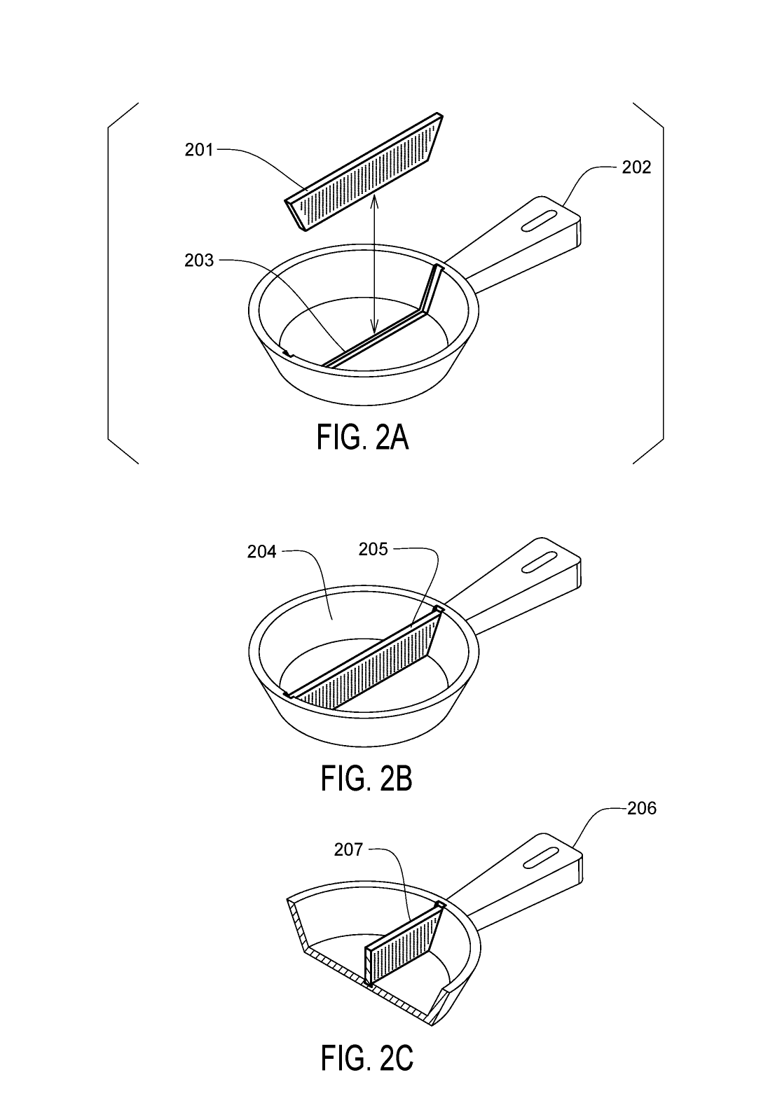

In reference to FIG. 2A, what is illustrated is a pan with an indented groove, and the plate.

In reference to tag 201, the plate.

In reference to tag 202, the pan handle.

In reference to tag 203, the indented or notched groove with two walls, which allows the plate to slide in between the two walls of the groove.

In reference to FIG. 2B, illustrated is a pan with the plate sitting inside of an indented groove.

In reference to tag 204, the pan.

In reference to tag 205, the plate sitting inside of the pan's indented or notched groove.

In reference to FIG. 2C, illustrated is an inside view of the pan with an indented groove, and the plate.

In reference to tag 207, the plate sitting inside of the pan's indented or notched groove.

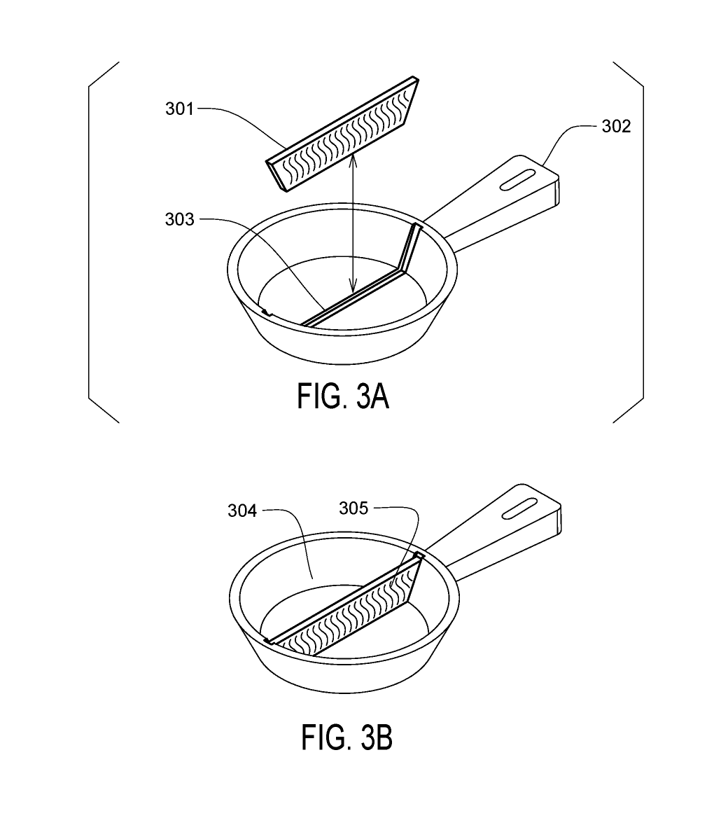

In reference to FIG. 3A, what is illustrated is a pan with an indented groove, and the plate.

In reference to tag 301, shown is the plate with an arrow connecting the plate with the indented

groove of the pan. The plate slides into the groove from the top of the pan.

In reference to tag 302, the pan handle.

In reference to tag 303, the indented or notched groove with two walls which the plate slides into.

In reference to FIG. 3B, what is illustrated is a pan with an indented groove, and the plate.

In reference to tag 304, the pan.

In reference to tag 305, illustrated is a perforated plate seated inside the pan.

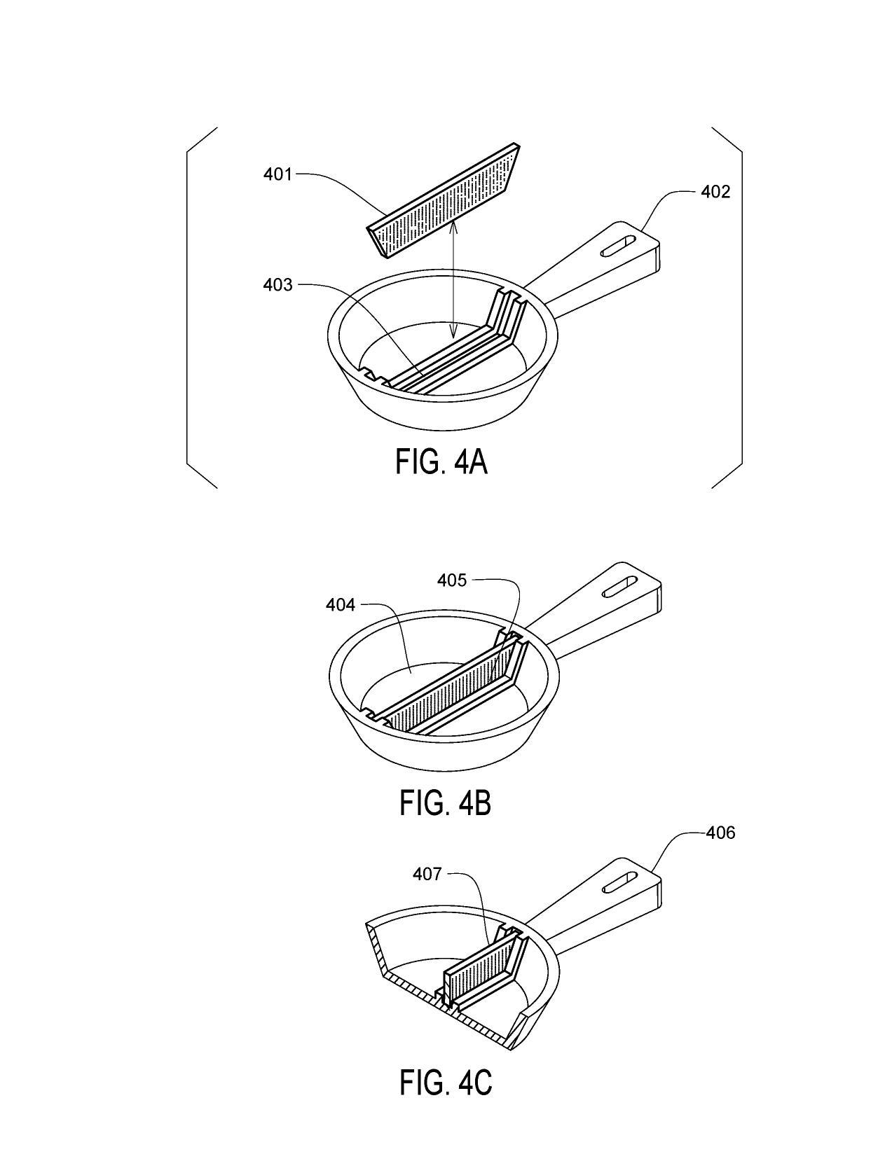

In reference to FIG. 4A, what is illustrated is a pan with a protruding groove with two walls, and a perforated plate which slides into the groove from the top of the pan.

In reference to tag 401, shown is the plate with an arrow connecting the plate with the protruding or projected groove of the pan. The plate slides into the groove from the top of the pan.

In reference to tag 402, the pan handle.

In reference to Tag 403, the protruding groove with two walls which the plate slides into.

In reference to FIG. 4B, what is illustrated is a pan with the plate sitting inside of a protruding groove.

In reference to tag 404, the pan.

In reference to tag 405, this is the plate as it sits in the protruding groove.

In reference to FIG. 4C, illustrated is an inside view of the pan with the plate sitting inside of a protruding groove.

In reference to tag 407, the plate.

What is claimed is:

1. The pan has a groove or slot with two walls in which the plate slides into, making it practically watertight, so that you can cook soups, sauces, or any liquidity foods with zero to very little transfer of liquids or the foods contents. The plate is removable and not fixed to the pan, so the pan may be used with or without the plate.
